(19) United States
(12) Patent Application Publication
(10) Pub. No.: US 2012/0246873 A1
(43) Pub. Date: Oct. 4, 2012

(54) HOLLOW ARTICLES COMPRISING FIBER-FILLED POLYESTER COMPOSITIONS, METHODS OF MANUFACTURE, AND USES THEREOF

(76) Inventors: Rama Konduri, Evansville, IN (US); Robert R. Gallucci, Mt. Vernon, IN (US); Scott Davis, Pittsfield, MA (US)

(21) Appl. No.: 13/078,432

(22) Filed: Apr. 1, 2011

(51) Int. Cl. G05G 1/00; B29D 22/00; B29C 49/06; B32B 1/08

(52) U.S. Cl. 16/110.1; 428/34.5; 264/504

(57) ABSTRACT

A hollow molded article is obtained by molding a thermoplastic polyester composition comprising a blend of reinforcing fiber glass, polybutylene terephthalate with a melting point of 210 to 230° C. and polyethylene terephthalate with a melting point of 240 to 260° C., wherein at least 10% of the outer surface of the article has a continuous glossy region with a gloss of at least 75 gloss units, as measured at 60 degrees in accordance with ASTM D523 and wherein the gloss varies from the average less than 10 gloss units in the glossy region. A gas-assisted injection molding process is also disclosed for making such hollow molded articles, which articles can have various uses, including handles for appliances or the like.

### BACKGROUND

This invention relates to hollow articles formed from glass fiber-filled polyester thermoplastic compositions, their method of manufacture, and uses of the articles.

Thermoplastic polyester compositions have valuable characteristics including mechanical strength, toughness, good gloss, and solvent resistance. Polyesters, therefore, have utility as materials for a wide range of applications, from automotive parts to electrical and electronic parts to home appliances. Polyesters are also used for molded items because of their high thermal and flow properties.

Glass or other reinforcing fibers are sometimes used to further improve mechanical and other properties. Such fibers can impart dimensional stability to the molded articles and decrease shrinkage of the article upon cooling in the mold. A problem has been, however, that surface roughness often arises from the inclusion of glass fibers in the polyester compositions used in the molded article. Particularly when the molded article is visible during use, for example, as a handle or other external part of an apparatus or its housing, it is desirable that the molded article possess satisfactory gloss with little or no surface roughness and without requiring a coating or further treatment to improve gloss.

It would, therefore, be desirable to obtain a molded article based on fiber-filled polyester compositions that have high gloss and no surface defects visible to the eye, which still has the advantages of glass fibers but without surface roughness due to glass fibers. For various reasons, it can also be desirable for such molded articles to have a hollow core.

Hollow molded articles can be made, among various molding techniques, by gas-assisted injection molding. Such a process utilizes an inert gas, for example nitrogen, to create one or more hollow channels within the molded article. In one such method, a polymer composition is injected into a mold and then an inert gas is injected into the melt either through a nozzle or a mold mounted injector pin. The gas forces the melt against the walls of the mold, forming a solid wall and a hollow cross-section. The gas follows the path of least resistance in forming hollow areas. Among the advantages of gas-assisted injection molding is improved dimensional stability and the elimination of sink marks. Gas-assisted injection molding can be applicable to thermoplastic materials that includes polypropylene, polycarbonate, nylon, and polyester, for use in making consumer goods, office equipment, computer enclosures, automotive parts, and the like.

U.S. Pat. No. 4,122,061 discloses a polyester molding composition reinforced with fiber glass comprising a combination of polybutylene terephthalate and polyethylene terephthalate, in combination with a linear low density polyethylene, for improved weld line strength in molding. U.S. Pat. No. 4,564,658 discloses another polyester molding composition reinforced with glass fiber that comprises a combination of polybutylene terephthalate and polyethylene terephthalate having, in addition, an impact modifier for improved impact strength. U.S. Pat. No. 6,187,848 discloses a polyester molding composition reinforced with glass fiber comprising a combination of polybutylene terephthalate and polyethylene terephthalate, which has increased color stability. The latter patent mentions applications that include oven handles or trim.

In general, the use of gas-assisted injection molding systems for the construction of one-piece plastic articles is known, for example, as described in U.S. Pat. No. 6,322,865; U.S. Pat. No. 6,462,167 and U.S. Pat. No. 7,255,818.

There remains a strong need for hollow articles made from glass-fiber filled polyester compositions that have excellent surface gloss in which further the glossy region of the article shows little variation in gloss and appearance, in addition to desirable mechanical properties such as impact strength.

### BRIEF SUMMARY OF THE INVENTION

In view of the above-described problems, the present invention is directed to a hollow molded article, comprising a surface of which at least a portion is a glossy surface, which is integrally molded from a thermoplastic polyester composition, (a) wherein said composition comprises: 28 to 50 wt. % polybutylene terephthalate with a melting point of 210 to 230° C., 10 to 30 wt. % of glass fiber with a diameter of 9 to 20 microns; 20 to 62 wt. % polyethylene terephthalate with a melting point of 240 to 260° C. and a diethylene glycol group content of 0.5 to 2.5 wt. %, and 0 to 5 wt. % of a colorant, an antioxidant, a mold release agent, a stabilizer, or a combination thereof, based on 100 parts by weight of the combination of the polybutylene terephthalate, glass fiber and polyethylene terephthalate; (b) wherein at least 10% of the surface area of the article has a glossy surface, which forms a continuous glossy region having a gloss of at least 75 gloss units, as measured at 60 degrees in accordance with ASTM D523; and (c) wherein the gloss varies from the average less than 10 gloss units in the glossy region. In one embodiment, the hollow molded article is made by a process in which the thermoplastic polyester composition is gas-assisted injection molded.

In another embodiment, the invention is directed to a hollow molded article, comprising a surface of which at least a portion is a glossy surface, which is integrally molded from a thermoplastic polyester composition, (a) wherein the composition comprises 35 to 45 wt. % polybutylene terephthalate with a melting point of 210 to 230° C., 10 to 20 wt. % of glass fiber with a diameter of 9 to 15 microns, 30 to 54.9 wt. % polyethylene terephthalate with a melting point of 240 to 260° C. and a diethylene glycol group content of 0.5 to 2.5 wt. %, 0.1 to 5 parts by weight of a colorant, based on 100 parts by weight of the combination of the polybutylene terephthalate, glass fiber and polyethylene terephthalate, and 0 to 5 wt. % of an antioxidant, a mold release agent, a stabilizer, or a combination thereof, based on 100 parts by weight of the combination of the polybutylene terephthalate, glass fiber and polyethylene terephthalate; (b) wherein at least 10% of the surface area of the article has the glossy surface, which forms a continuous glossy region having a gloss of at least 80 gloss units, as measured at 60 degrees in accordance with ASTM D523; and (c) wherein gloss varies from the average less than 10 gloss units in the glossy region.

Specifically, gloss varies from the average less than 7.5 gloss units in the glossy region of the hollow molded article.

Also disclosed is a method for the manufacture of the foregoing hollow molded articles by gas-assisted injection molding. In particular, hollow molded articles having excellent surface gloss can be obtained.

Finally, another aspect of the invention relates to the use of such hollow molded articles as handles for various apparatus, including large appliances. Such handles that can be manually grasped for moving the entire appliance or a part thereof.

### DETAILED DESCRIPTION OF THE INVENTION

Our invention is based on the discovery that it is possible to make hollow molded articles comprised of a glass-fiber reinforced polyester composition that provides uniformly excellent surface gloss such that the glossy region has a gloss of at least 75 gloss units, as measured at 60 degrees in accordance with ASTM D523, and the gloss varies from the average less than 10 gloss units in the glossy region. Such hollow molded articles, comprising the glass-filled polyester composition, can also exhibit desirable mechanical properties. In particular, the articles can exhibit useful impact strength properties and heat stability, in addition to high gloss, on its outer or visible surface, free of surface defects.

As used herein the singular forms “a,” “an” and “the” include plural referents. The term “combination” is inclusive of blends, mixtures, alloys, reaction products, and the like and may include more than one of component of each type specified. Unless defined otherwise, technical and scientific terms used herein have the same meaning as is commonly understood by one of skill. Compounds are described using standard nomenclature. The term “and a combination thereof” is inclusive of the named component and/or other components not specifically named that have essentially the same function.

Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. The endpoints of all ranges reciting the same characteristic or component are independently combinable and inclusive of the recited endpoint. Unless expressly indicated otherwise, the various numerical ranges specified in this application are approximations. The term “from more than 0 to” an amount means that the named component is present in some amount more than 0, and up to and including the higher named amount.

All ASTM tests and data are from the 2003 edition of the Annual Book of ASTM Standards unless otherwise indicated. All cited references are incorporated herein by reference.

The hollow molded articles of the present invention may be used as a component for a large appliance, a vehicle, office equipment, luggage, or an electronic consumer device.

A large appliance, as used herein, is defined as a machine that accomplishes some routine housekeeping task, which includes purposes such as cooking, food preservation, or cleaning, whether in a household, institutional, commercial or industrial setting. Examples of large appliances include, but are not limited to, ovens, refrigerators, freezers and dishwashers. Such large appliances can have a volume of more than 10,000 cm³, specifically han 100,000 cm³. For example a dishwasher can have a volume of about 300,000 cm³.

For the sake of clarity, the terms “terephthalic acid group,” “isophthalic acid group,” “butanediol group,” and “ethylene glycol group” have the following meanings. The term “terephthalic acid group” in a composition refers to a divalent 1,4-benzene radical (−1,4-(C₆H₄)—) remaining after removal of the carboxylic groups from terephthalic acid. The “butanediol group” refers to a divalent butylene radical (—(C₄H₈)—) remaining after removal of hydroxyl groups from butanediol. The term “ethylene glycol group” refers to a divalent ethylene radical (—(C₂H₄)—) remaining after removal of hydroxyl groups from ethylene glycol. The term “diethylene glycol group” refers to a divalent diethylene radical (—(C₂H₄OC₂H₄)—) remaining after removal of hydroxyl groups from diethylene glycol. With respect to the terms “terephthalic acid group,” “ethylene glycol group,” “butanediol group,” and “diethylene glycol group” being used in other contexts, e.g., to indicate the weight % of the group in a composition, the term “isophthalic acid group(s)” means the group having the formula (—O(CO)C₆H₄(CO)—), the term “terephthalic acid group” means the group having the formula (—O(CO)C₆H₄(CO)—), the term diethylene glycol group means the group having the formula (—O(C₂H₄)O(C₂H₄)—), the term “butanediol group” means the group having the formula (—O(C₄H₈)—), and the term “ethylene glycol group” means the group having formula (—O(C₂H₄)—).

As indicated above, the present hollow articles are made from a special blend of thermoplastic compositions. Polyesters, in general, having repeating structural units of formula (I)

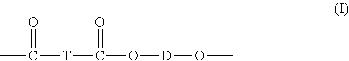

wherein each T is independently the same or different divalent C₆₋₁₀ aromatic group derived from a dicarboxylic acid or a chemical equivalent thereof, and each D is independently a divalent C₂₋₄ alkylene group derived from a dihydroxy compound or a chemical equivalent thereof.

Copolyesters can contain a combination of different T and/or D groups. Chemical equivalents of diacids include the corresponding esters, alkyl esters, e.g., C₁₋₃ dialkyl esters, diaryl esters, anhydrides, salts, acid chlorides, acid bromides, and the like. Chemical equivalents of dihydroxy compounds include the corresponding esters, such as C₁₋₃ dialkyl esters, diaryl esters, and the like. The polyesters can be branched or linear. Exemplary polyesters include poly(alkylene terephthalate) (“PAT”), poly(1,4-butylene terephthalate), (“PBT”), poly(ethylene terephthalate) (“PET”), poly(ethylene naphthalate) (“PEN”), poly(butylene naphthalate), (“PBN”), poly(propylene terephthalate) (“PPT”), poly(cyclohexane dimethanol terephthalate) (“PCT”), poly(cyclohexane-1,4-dimethylene cyclohexane-1,4-dicarboxylate) also known as poly(1,4-cyclohexanedimethanol 1,4-dicarboxylate) (“PCCD”), poly(cyclohexanedimethanol terephthalate), poly(cyclohexylenedimethylene-co-ethylene terephthalate), cyclohexanedimethanol-terephthalic acid-isophthalic acid copolymers and cyclohexanedimethanol-terephthalic acid-ethylene glycol (“PCTG” or “PETG”) copolymers. When the molar proportion of cyclohexanedimethanol is higher than that of ethylene glycol the polyester is termed PCTG. When the molar proportion of ethylene glycol is higher than that of cyclohexane dimethanol the polyester is termed PETG.

Polyesters can be obtained by methods well known to those skilled in the art, including, for example, interfacial polymerization, melt-process condensation, solution phase condensation, and transesterification polymerization. Such polyester resins are typically obtained through the condensation or ester interchange polymerization of the diol or diol equivalent component with the diacid or diacid chemical equivalent component. Methods for making polyesters and the use of polyesters in thermoplastic molding compositions are known in the art. Conventional polycondensation procedures are described in the following, see, generally, U.S. Pat. Nos. 2,465,319, 5,367,011 and 5,411,999. The condensation reaction can be facilitated by the use of a catalyst, with the choice of catalyst being determined by the nature of the reactants. The various catalysts are known in the art. For example, a dialkyl ester such as dimethyl terephthalate can be transesterified with butylene glycol using acid catalysis, to generate poly(butylene terephthalate). It is possible to use branched polyester in which a branching agent, for example, a glycol having three or more hydroxyl groups or a trifunctional or multifunctional carboxylic acid has been incorporated.

In the polyester composition comprising the article of the present invention, the ratio of polybutylene terephthalate to polyethylene terephthalate can specifically vary from 0.50 to 1.20.

Without wishing to be bound by theory, the use of polyethylene terephthalate with a diethylene glycol group content of from 0.5 to 2.5 wt. %, more specifically 0.7 to 2.0 wt. %, is believed to contribute to the glossiness of the article surface by affecting the onset and/or rate of crystallization. During gas-assist molding the molten polyester is pushed against the relatively cold walls of the tool cavity and its crystallization is believed to significantly affect the surface gloss produced as the material solidifies.

Specifically, the polyester composition can comprise 35 to 45 wt. % polybutylene terephthalate, with a melting point of 210 to 230° C., and 10 to 20 wt. % of glass fiber with a diameter of 9 to 15 microns.

Commercial examples of polybutylene terephthalate include, for example, those available under the trade names VALOX 315 and VALOX 195, manufactured by SABIC Innovative Plastics. Commercial examples of polyethylene terephthalate are commonly available from a variety of suppliers. Polyethylene terephthalate that comprises terephthalic acid, ethylene glycol, and diethylene glycol (DEG) groups can be made employing conventional processes. Processes and catalysts for making polyethylene terephthalate are described, for example, in WO 2010/105787 and WO 2010/102795. The DEG content can be determined by transesterifying the polymer with methanol in an autoclave at 220° C., by which the polymer is depolymerized, and the DEG liberated as the diol. The liquid formed can then be analyzed by gas chromatography.

In one embodiment, the polyethylene terephthalate can have an intrinsic viscosity, of 0.50 to 1.10 dl/g and the polybutylene terephthalate can have an intrinsic viscosity of 0.5 to 0.9 dl/g, wherein deciliters per gram is measured in a 60:40 by weight phenol/1,1,2,2-tetrachloroethane mixture at 23° C.

A mixture of polyester resins of the same polyester formula, with differing viscosities, can be used to make a blend in order to allow for control of viscosity of the final formulation. Surprisingly, as shown herein in Table 2, it was found that the intrinsic viscosity of the polyethylene terephthalate in the polyester composition did not significantly impact the gloss obtained, for the viscosities actually tested, as compared to the diethylene glycol group content.

A combination a virgin polyester (polyesters derived from monomers) and recycled or modified polyester can also be utilized, including virgin and/or modified poly(1,4-butylene terephthalate) obtained from recycled polyethylene terephthalate. Modified polybutylene terephthalate, in addition to comprising terephthalic acid groups and butanediol groups, can also comprise residues diethylene glycol.

Also contemplated herein is optionally from 0.1 to 10 wt. %, specifically 0 to 5 wt. % based on the total weight of the polymers in the composition used herein, of further polyesters. Such polyesters can be selected from the group consisting of polyethylene naphthalate, polybutylene naphthalate, polytrimethylene terephthalate, poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), or a combination comprising at least one of the foregoing polyesters.

Such optional polyesters can comprising minor amounts, e.g., 0.5 to 30 wt %, of units derived from aliphatic acids and/or aliphatic polyols to form copolyesters. The aliphatic polyols include glycols, such as poly(ethylene glycol). Such polyesters can be made following the teachings of, for example, U.S. Pat. Nos. 2,465,319 to Whinfield et al., and 3,047,539 to Pengilly. Optional polyesters comprising block copolyester resin components are also contemplated, and can be prepared by the transesterification of (a) straight or branched chain poly(alkylene terephthalate) and (b) a copolyester of a linear aliphatic dicarboxylic acid and, optionally, an aromatic dibasic acid such as terephthalic or isophthalic acid with one or more straight or branched chain dihydric aliphatic glycols. Of use when high melt strength is important are branched high melt viscosity resins, which include a small amount of, e.g., up to 5 mole percent based on the acid units of a branching component containing at least three ester forming groups. The branching component can be one that provides branching in the acid unit portion of the polyester, in the glycol unit portion, or it can be a hybrid branching agent that includes both acid and alcohol functionality. Illustrative of such branching components are tricarboxylic acids, such as trimesic acid, and lower alkyl esters thereof, and the like; tetracarboxylic acids, such as pyromellitic acid, and lower alkyl esters thereof, and the like; or preferably, polyols, and especially preferably, tetrols, such as pentaerythritol; triols, such as trimethylolpropane; dihydroxy carboxylic acids; and hydroxydicarboxylic acids and derivatives, such as dimethyl hydroxyterephthalate, and the like. Branched poly(alkylene terephthalate) resins and their preparation are described, for example, in U.S. Pat. No. 3,953,404 to Borman. In addition to terephthalic acid units, small amounts, e.g., from 0.5 to 15 mole percent of other aromatic dicarboxylic acids, such as isophthalic acid or naphthalene dicarboxylic acid, or aliphatic dicarboxylic acids, such as adipic acid, can also be present, as well as a minor amount of diol component other than that derived from 1,4-butanediol, such as ethylene glycol or cyclohexane dimethanol, etc., as well as minor amounts of trifunctional, or higher, branching components, e.g., pentaerythritol, trimethyl trimesate, and the like. The polyester composition can also optionally further comprise from 0 to 10 wt. %, specifically 0 to 5 wt. %, based on the total weight of the polymers in the composition, of an aromatic copolyester carbonate.

Any of the foregoing optional polyesters can have an intrinsic viscosity of 0.4 to 2.0 deciliters per gram (dL/g), measured in a 60:40 by weight phenol/1,1,2,2-tetrachloroethane mixture at 23° C. The optional polyesters can have a weight average molecular weight of 10,000 to 200,000 Daltons, specifically 50,000 to 150,000 Daltons as measured by gel permeation chromatography (GPC).

The thermoplastic polyester composition for making the hollow molded articles of the present invention further comprises glass fibers that can typically have a modulus of greater than or equal to about 6,800 megaPascals (MPa), and which can be chopped or continuous. The glass fiber can have various cross-sections, for example, round, trapezoidal, rectangular, square, crescent, bilobal, trilobal, and hexagonal. In one embodiment, the glass is relatively soda free. Fibrous glass fibers comprised of lime-alumino-borosilicate glass, which is also known as “E” glass are especially preferred. Glass fiber can greatly increase the flexural modulus and strength. The glass fibers can be made by standard processes, e.g., by steam or air blowing, flame blowing and mechanical pulling. Specifically, such filaments can be made employing mechanical pulling. A fiber diameter of from 9 to 20 microns, specifically 10 to 15 microns, is used. In preparing the molding compositions, it is convenient to use the fiber in the form of chopped strands of from about ⅛″ (3 mm) to about ½″ (13 mm) in length, although roving may also be used. In articles molded from the compositions, the fiber length is typically shorter presumably due to fiber fragmentation during compounding of the composition. The length of such short glass fibers present in final molded compositions can be less than about 4 mm.

The fibers can be treated with a variety of coupling agents to improve adhesion to the resin matrix. Examples of coupling agents include alkoxy silanes and alkoxy zirconates, amino, epoxy, amide or mercapto functionalized silanes. Organometallic coupling agents, for example, titanium or zirconium based organometallic compounds, can also be used. Sizing-coated glass fibers are commercially available from Owens Corning Fiberglass as, for example, OCF K filament glass fiber 183F.

The glass fibers can be blended first with the polyester composition and then fed to an extruder and the extrudate cut into pellets, or, in a specific embodiment, they may be separately fed to the feed hopper of an extruder. In one embodiment, the glass fibers can be fed downstream in the extruder to minimize attrition of the glass. Generally, for preparing pellets of the polyester composition used herein, the extruder can be maintained at a temperature of approximately 480° F. to 550° F. The pellets so prepared when cutting the extrudate can be one-fourth inch long or less. As stated previously, such pellets contain finely divided uniformly dispersed glass fibers in the composition. The dispersed glass fibers are reduced in length as a result of the shearing action on the chopped glass strands in the extruder barrel.

The glass fiber is present in the polyester composition in an amount from 10 to 30 wt. %, more specifically from 10 to 20 wt. % by weight.

In still other embodiments, the compositions can optionally comprise a particulate (non-fibrous) organic filler, which can impart additional beneficial properties to the compositions such as thermal stability, increased density, stiffness, and/or texture. Exemplary particulate fillers are alumina, amorphous silica, alumino silicates, mica, clay, talc, glass microspheres, metal oxides such as titanium dioxide, zinc sulfide, ground quartz, and the like. When present, the particulate filler is used in an amount from more than zero to 3 wt. %, specifically more than 0 to 2 wt. %, more specifically from 0.1 to 1 wt. %.

The thermoplastic polyester composition can optionally further comprise any of the additives and property modifiers that polyesters are usually combined with, with the proviso that the additives are selected so as to not significantly adversely affect the desired properties of the composition, for example, surface gloss. Exemplary additives include, for example, antioxidants, flame retardants, heat stabilizers, light stabilizers, antistatic agents, colorants, mold release agents, and other additives for the purpose of imparting desired properties corresponding to the product being made. As used herein, a “stabilizer” is inclusive of an antioxidant, a thermal stabilizer, radiation stabilizer, ultraviolet light absorbing additive, and the like, and combinations thereof. In one embodiment, both an antioxidant and further stabilizer is used, including a plurality of antioxidants or an antioxidant and a thermal stabilizer.

For example, the thermoplastic composition can optionally further comprises inorganic phosphorus compounds as stabilizers. These inorganic phosphorus compounds can be inorganic compounds selected from phosphoric acid, phosphorous acid, and metal salts of phosphoric acid and phosphorous acid; specifically, metal salts of phosphoric acid, such as zinc phosphate, potassium phosphate, sodium phosphate, aluminum phosphate, sodium pyrophosphate, etc., and their hydrates, and the corresponding metal phosphates, can be listed as metal salts of phosphoric acid and phosphorous acid. Such inorganic phosphorus compounds are generally used in amounts of 0.05 to 0.5 parts by weight, based on the total weight of the composition.

Antioxidants can also include a hindered diol stabilizer, a thioester stabilizer, an amine stabilizer, a phosphite stabilizer, a phosphonite stabilizer, or a combination comprising at least one of the foregoing types of stabilizers. In one embodiment, the polyester composition comprises from 0.01 to 0.50 wt. % of antioxidant selected from the group consisting of phosphites, phosphonites and mixtures thereof. More specifically, the polyester composition can comprise antioxidant selected from the group consisting of alky aryl phosphite, alkyl aryl phosphonites, and mixtures thereof.

Such antioxidants specifically include organophosphites such as tris(2,6-di-tert-butylphenyl)phosphite, tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, commercially available from BASF Company as Irganox 1010; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate, pentaerythrityl-tetrakis(beta-lauryl thiopropionate) (available under the trade name Seenox 412S), or the like; amides of beta-(3,5-di-tert-butyl-4-hydroxyphenyl)-propionic acid or the like; or combinations comprising at least one of the foregoing antioxidants.

One exemplary antioxidant composition comprises tetrakis(2,4-di-tert-butylphenyl) 4,4′-biphenylene diphosphonite, which is available under the trade name SANDOSTAB® P-EPQ, from Clariant. The antioxidant composition can also consist essentially of, or consist of, tetrakis[methylene(3,5-di-tert-butyl-4-hydroxyhydrocinnamate)]methane.

When present, the antioxidants are be used in an amount of 0.0001 wt. % to 2 wt. %, more specifically 0.01 wt. % to 0.5 wt. %, based on the total weight of the thermoplastic polyester composition.

A wide variety of mold release agents can be used, for example phthalic acid esters such as dioctyl-4,5-epoxy-hexahydrophthalate; tristearin; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a suitable solvent; and waxes such as beeswax, paraffin wax, or the like. In one embodiment, the mold release agent is a salt or an ester of one or more long chain, aliphatic carboxylic acids having from 12 to 36 carbon atoms. Such materials are generally used in amounts of 0.1 to 0.5 parts by weight, based on the total weight of the composition.

In one embodiment, the polyester composition further comprises from 0.1 to 1.0 wt. % of a mold release agent selected from the group consisting of aliphatic polyesters, poly-alpha-olefins, aliphatic polyamides, carboxylic acid salts, and mixtures thereof.

Suitable colorants for hollow molded article can include those known for use in molding compositions, including inorganic and organic pigments and dyes. Exemplary colorants include metal oxides and oxide-hydroxides, mixed metal oxides, titanates, aluminates, carbonates, iron oxides, chromium oxides, ultramarines and metal sulfides, sulfoselenides, rare-earth sulfides, chromium iron oxides, chromium iron nickel spinel, chromium green, black hematite, bismuth vanadate, chromates, nitrides (including, but not limited to tantalum), iron blue, cobalt and manganese phosphates, europium complexes, and carbon black. Organic colorants include azo dyes, methine dyes, coumarins, pyrazolones, quinophthalones, quinacridones, perinones, anthraquinones, phthalocyanines, perylene derivatives, anthracene derivatives, indigoid and thioindigoid derivatives, imidazole derivatives, napthalimide derivatives, xanthenes, thioxanthenes, azine dyes, polyazaindacenes, benzoxazole, pyrazolines, fluoroscein, benzothiazole, hydroxyflavones, bis(hydroxyflavones), stilbenes, thiophene, rhodamines, and all their derivatives.

In one embodiment, the hollow molded article of the present invention also includes 0.1 to 5 wt. % of a colorant, based on 100 parts by weight of the combination of the polybutylene terephthalate, glass fiber and polyethylene terephthalate. Specifically, where the article is to be black, the composition can contain carbon black, or other black colorants known in the art. More specifically, the composition can contain carbon black having a particle size of 10 to 25 nm. Where the article is to be white, the composition can contain zinc sulfide or other white colorants known in the art. Where the article is to be gray, the composition can contain colorants known in the art to impart a gray color, more specifically a combination of carbon black and zinc sulfide.

With the proviso that surface properties and mechanical properties are not significantly adversely affected, the compositions can optionally further comprise still other conventional additives used in polyester polymer compositions such as plasticizers, quenchers, lubricants, antistatic agents, processing aids, laser marking additives, and the like. A combination comprising one or more of the foregoing or other additives can be used.

For making the hollow molded articles, the thermoplastic polyester compositions can be prepared by blending the components of the composition, employing a number of procedures. In an exemplary process, the polyester component, reinforcing glass fiber, and stabilizer are placed into an extrusion compounder to produce molding pellets or the like. The components are dispersed in a matrix in the process. Preferably, all of the components are freed from as much water as possible, frequently by the use of vacuum venting during extrusion. In addition, compounding is carried out to ensure that the residence time in the machine is short; the temperature is carefully controlled; the friction heat is utilized; and an intimate blend between the components is obtained.

For example, after pre-drying the polyester composition (e.g., for four hours at 120° C.), a single screw extruder can be fed with a dry blend of ingredients, in which the screw employed having a long transition section to ensure proper melting. Alternatively, a twin-screw extruder with intermeshing co-rotating screws can be fed with resin and additives at the feed port and reinforcing additives (and other additives) can be fed downstream. In either case, a melt temperature of 230° C. to 300° C. can be used in one embodiment. The pre-compounded composition can be extruded and cut up into molding compounds such as conventional granules, pellets, and the like by standard techniques. The pre-compounded composition can be molded by injection molding techniques. Specifically, the polyester composition can be molded in equipment adapted for gas-assisted molding.

In one embodiment, the method of making the hollow molded articles comprises mixing the components of the polyester composition, introducing the polyester composition as a molten material into a molding apparatus adapted for gas-assisted molding and then, at the end of the filling stage, introducing a gas such as nitrogen into the still liquid core of the molding in the molding cavity to hollow the article. The gas in such a process follows the path of least resistance and can replace a thick molten section with a gas-filled channel. Gas pressure can pack the molten polyester composition against the relatively cold mold cavity surface. Subsequently, the gas can be vented from the molding apparatus, either to the atmosphere or recycled. After a preselected period of time, the solid molded hollow article that has been formed can be removed from molding apparatus. In one embodiment, the gas-assisted injection molding can be molded at a melt temperature of 260 to 290° C.

Thus, a hollow molded article of a one-piece construction can be integrally molded or formed from a the thermoplastic polyester composition by conventional injection molding equipment having an article-defining cavity and an injection aperture wherein the molten polyester composition is injected and an injection aperture wherein pressurized fluid, specifically a gas, such as air, dehumidified air, nitrogen or argon, is communicated to the molten polyester composition in the article defining cavity to at least partially distribute the molten resin, expanding the polymeric melt and replicating the surface and shape of the mold. The molten polyester composition is then is then cooled to a solid. A hollow core can be formed by the pressurized fluid that is defined by the gas channel that can extends at least partially through a hollow body section of the article. In a specific embodiment, the gas channel extends completely through the hollow body of the article.

The hollow articles made according to this invention have various application, including consumer goods, office equipment, computers, office equipment, electronic or communication devices, automotive parts, domestic or industrial machine tools, lawn equipment, and especially domestic appliances. The term “automotive” refers to applications with respect to any vehicle of transportation, for example cars, trucks, motor bicycles, boats, and sport vehicles. For example, hollow molded articles can be used in luggage racks or spoilers, in which lighter weight is an advantage.

As indicated above, the term “appliances” refers to machines such as ovens, fridges, and other kitchen appliances. In one advantageous application, the hollow molded article can be used as a handle for an appliance, luggage, a door, or the like, in which substantially at least the visible outer surface of the handle can have a gloss of more than 75 gloss units. A method of using such hollow molded articles, in the form of an integrally formed handle that is permanently attached to an apparatus, therefore, comprises a person manually grasping the handle and thereby moving the apparatus or a moveable part thereof. Specifically, such a handle can be attached to a home appliance, for example, the door of an oven or refrigerator. In one embodiment, the hollow molded article is 0.5 to 6.0 inches wide, 6 to 40 inches long, and has a wall thickness 0.05 to 0.4 inch.

At least 10% of the surface area of the hollow molded article can have a glossy surface, which can form a continuous glossy region having a gloss of at least 75 gloss with a gloss variation from the average of less than 10 gloss units in the glossy region. Specifically at least 30%, more specifically at least 40%, of the surface area of the hollow area can have such a glossy surface. A portion of the surface of the hollow article can optionally be non-glossy or textured. For example, in the case of a handle, the backside of the handle opposite to the visible glossy region can be textured for ease of grasping or pulling. Such textured surfaces can be formed by the cavity surface of the tool used for molding.

As described above, the hollow molded articles of the present invention are extremely excellent in terms of surface gloss and, more specifically, (i) a gloss (ASTM D523) that is at least 80 gloss units, as measured at 60 degrees, and (ii) a gloss that from the average less than 7.5 gloss units in the glossy region, more specifically less than 6 percent, and (iii) the absence of surface defects visible to the eye on a surface thereof. Furthermore, a molded sample (or pellets in the case of MVR) of the polyester compositions used to make the hollow molded articles can meet certain minimum targeted performance properties with respect to a menu of properties comprising (i) a melt viscosity (MVR), as measured by ASTM D1238, at 265° C. for 360 seconds using a 5 kg weight after equilibrating for 360 sec, of from 30 to 60 cm³/10 min, and after equilibrating for 1080 sec, of from 40 to 90 cm³/10 min, (ii) a heat deflection temperature of greater than 200° C. at 66 psi (0.455 MPa) as measured by ASTM D648, and (iii) an Izod notched impact strength of at least 40 J/m, in accordance with ASTM D246.

In terms of uniformity of gloss, the variation is measured, as in the Examples herein, by measuring the interior of glossy region at each of six equally spaced adjacent locations within the boundary of the glossy region, between end points, specifically from the direction of the end gate of the article, specifically in the longitudinal direction of the glossy region, calculating the average gloss, and then taking the standard deviation. Measurement of gloss can be obtained with a standard Tri-Gloss meter. In one embodiment, the glossy region has a length of at least 12 cm, specifically at least 18 cm, more specifically at least 20 cm.

In one embodiment, the hollow molded article made from a polyester composition can exhibit a gloss (ASTM D 523) that is at least 85 gloss units, as measured at 60 degree, and can exhibit a gloss that varies from the average less than 6 gloss units. In addition, the article can be made with no surface defects in the glossy region that visible to the eye.

In another embodiment, the hollow molded article is made by a gas-assisted injection-molded article using a polymer composition and has (i) a gloss (ASTM D 523) that is at least 80 gloss units, as measured at 60 degrees, and (ii) a gloss that varies from the average less than 7.5 gloss units, wherein a molded sample of the polyester composition used to make the hollow molded article simultaneously exhibits the following properties: (i) a melt viscosity (MVR), as measured by ASTM D1238, at 265° C. for 360 seconds using a 5 kg weight after equilibrating for 360 sec, of from 30 to 60 cm³/10 min, and at 265° C., using a 5 kg weight after equilibrating for 1080 sec, of from 40 to 90 cm³/10 min (ii) a heat deflection temperature of greater than 200° C. at 66 psi (0.455 MPa), and (iii) an Izod notched impact strength of greater than 40 J/m, in accordance with ASTM D246.

The invention is further illustrated by the following non-limiting examples, in which all parts are by weight unless otherwise stated.

### EXAMPLES

### Materials

The following materials are used in Examples 1 to 2 and Comparative Examples A to F. Table 1 shows the nomenclature used as well as a description.

TABLE 1

| Raw Materials | Description |
|---|---|
| PBT 195 | Poly(1,4-butylene terephthalate), intrinsic viscosity |
| | (IV) = 0.66 dl/g, Mw weight-average molecular |
| | weight = 53400 g/mol, Tm 215° C. |
| PBT 315 | Poly(1,4-butylene terephthalate), intrinsic viscosity |
| | (IV) = 1.10 dl/g, Mw weight-average molecular |
| | weight = 110000 g/mol, Tm 217° C. |
| Low IV PET | 0.535 dl/g IV PET, 0.8% DEG, Tₘ 257° C. |
| Hi IV PET | 0.83 dl/g IV PET, 0.8% DEG, Tₘ 242° C. |
| Glass Fiber | Owens Corning 183F 13 micron diameter E glass |
| Mold Release | Penta erythritol tetra stearate (PETS) |
| Antioxidant 1 | PEPQ phosphonite from Clariant |
| Antioxidant 2 | Diphenyl isodecyl phosphite |
| Carbon black | 25 wt % 17 nm particle size carbon black in PBT 195 |
| Silica | Precipitated amorphous silica process aid |

### General Testing Techniques and Procedures:

Gloss was measured per ASTM D523 at six different locations in a glossy region, at equally spaced distances apart between two end points, starting from the direction of the gate end of the part. Specifically, for the molded handle in the examples, gloss was measured per ASTM D523 at six different locations on the topside of the molded handle approximately 1.5 inches (3.8 cm) apart starting from the gate end of the part. An average gloss was calculated. The gloss variation is taken as the standard deviation based on the gloss measurements.

Melt viscosity (MVR) was measured as per ASTM D1238 at 265° C. using a 5 kg weight, on pellets dried for at least 2 hr at 125° C. the melt was allowed to equilibrate for 6 (360 sec.) or 18 (1080 sec.) minutes.

Differential Scanning Calorimetry (DSC) data was measured on pellets using a 20° C. heating rate. Onset melting, heat of fusion/melting, onset crystallization temperature (Tc), heat of crystallization (delta Hc), and peak melting temperature, were determined by DSC in a fashion similar to ASTM D3418.

Notched Izod testing was performed on 75 mm×12.5 mm×3.2 mm bars in accordance with ASTM D256 using a 5 lb hammer.

The heat distortion temperature (HDT) test was performed by placing HDT samples at load of 0.45 MPa (66 psi) and heating rate of 120° C./hr.

### Extrusion/Molding Procedures

The components as shown in Table 1 (amounts expressed in percent weight, based on the total weight of the polymer composition) are blended together in a drum tumbler and then extruded on a 44-mm twin-screw extruder with a vacuum vented mixing screw, at a barrel temperature set at 250° C. and a screw speed of 200 rpm and throughput rate of 100 kg per hour. The extruded pellets are dried at 120° C. for at least two hours before injection molding.

The sample articles for testing were molded from the sample polyester compositions in an gas-assisted injection molding apparatus the corresponding polyester composition was injected into the mold at a 260 to 290° C. melt temperature. Subsequently, nitrogen gas was injected into the mold to produce a gas channel through the molten material. Gas assist molding was done on a 350 ton Sumitomo molding machine with 100 rpm screw speed, a mold temperature of about 93° C., a 2 to 5 sec. injection time, 15 to 20 sec. pack time, a 20 to 40 sec. cooling time and a 40 to 60 sec. cycle time. Injection pressure was about 450 to 650 psi.

The part molded was a hollow handle approximately 15 in. long, 1 in. wide, and 2 inches high. The upper exterior surface was about 11 inches long, about 1 inch wide, with a smooth glossy finished topside. The underside of the part, which was about 0.75 inches below the topside, was a textured finger grip surface. The ends of the part were tapered triangular shapes about 2 inches long ending in a flat base for attachment to a door.

### Examples 1-2 and Comparative Examples A-F

The purpose of Examples 1-2 is to make a glass-filled polyester composition containing various ratios of PET and PBT and evaluate their performance with regard to the gloss and other relevant properties. Thus, the compositions were evaluated to determine their performance properties with respect to a menu of properties, with particular attention to meeting minimum requirements in terms of the specified gloss.

The purpose of Comparative Examples A to F was to compare the performance properties of the compositions of Examples 1-2 with a polyester composition that contains no PBT (Comparative Examples E and F) or that contains a relatively high ratio (Comparative Example A and B) or that contains a relatively lower ratio in various amounts (Comparative Examples C and D).

TABLE 2

| | | Examples | | | | | | | |
|---|---|---|---|---|---|---|---|---|---|
| | | Comp. | Comp. | Comp. | Comp. | Comp. | Comp. | | |
| | Amt. | Ex. A | Ex. B | Ex. C | Ex. D | Ex. E | Ex. F | Ex. 1 | Ex. 2 |
| PBT 315, high Mw | wt. % | 39.8 | 32.1 | 7.7 | 7.7 | 0 | 0 | 23 | 23 |
| PBT 195, low Mw | wt. % | 27.55 | 20.25 | 4.65 | 4.65 | 0 | 0 | 14.35 | 14.35 |
| Low IV PET | wt. % | 15 | 30 | 70 | 0 | 82.35 | 0 | 45 | 0 |
| High IV PET | wt. % | 0 | 0 | 0 | 70 | 0 | 82.35 | 0 | 45 |
| 13 micron Fiber | wt. % | 15 | 15 | 15 | 15 | 15 | 15 | 15 | 15 |
| Glass | | | | | | | | | |
| Mold release agent | wt. % | 0.1 | 0.1 | 0.1 | 0.1 | 0.1 | 0.1 | 0.1 | 0.1 |
| Silica, precipitated | wt. % | 0.2 | 0.2 | 0.2 | 0.2 | 0.2 | 0.2 | 0.2 | 0.2 |
| amorphous | | | | | | | | | |
| Antioxidant 1 | wt. % | 0.05 | 0.05 | 0.05 | 0.05 | 0.05 | 0.05 | 0.05 | 0.05 |
| Antioxidant 2 | wt. % | 0.3 | 0.3 | 0.3 | 0.3 | 0.3 | 0.3 | 0.3 | 0.3 |
| 25% CB PBT 195 | wt. % | 2.0 | 2.0 | 2.0 | 2.0 | 2.0 | 2.0 | 2.0 | 2.0 |
| masterbatch | | | | | | | | | |
| PBT/PET ratio | | 4.6 | 1.8 | 0.20 | 0.20 | 0.018 | 0.018 | 0.86 | 0.86 |

TABLE 3

| | | Examples | | | | | | | |
|---|---|---|---|---|---|---|---|---|---|
| | | Comp. | Comp. | Comp. | Comp. | Comp. | Comp. | | |
| | Units | Ex. A | Ex. B | Ex. C | Ex. D | Ex. E | Ex. F | Ex. 1 | Ex. 2 |
| Part length with surface | cm | 15 | 9 | 15 | 15 | 15 | 15 | 0 | 0 |
| glass (defects) showing | | | | | | | | | |
| Defects showing on | NA | yes | yes | yes | yes | yes | yes | no | no |
| surface | | | | | | | | | |
| Article zone 1 | gloss | 20 | 26 | 23 | 19 | 24 | 10 | 88 | 88 |
| 60 degree gloss | | | | | | | | | |
| Article zone 2 | gloss | 28 | 48 | 32 | 30 | 56 | 13 | 84 | 89 |
| 60 degree gloss | | | | | | | | | |
| Article zone 3 | gloss | 33 | 88 | 40 | 25 | 47 | 15 | 91 | 91 |
| 60 degree gloss | | | | | | | | | |
| Article zone 4 | gloss | 57 | 83 | 35 | 19 | 47 | 13 | 92 | 95 |
| 60 degree gloss | | | | | | | | | |
| Article zone 5 | gloss | 60 | 71 | 30 | 25 | 43 | 10 | 85 | 88 |
| 60 degree gloss | | | | | | | | | |
| Article zone 6 | gloss | 62 | 79 | 18 | 18 | 24 | 10 | 85 | 80 |
| 60 degree gloss | | | | | | | | | |
| Avg. 60 degree gloss | gloss | 43 | 66 | 30 | 23 | 40 | 12 | 88 | 89 |
| Standard deviation | gloss | 18 | 24 | 8 | 5 | 13 | 2 | 3 | 5 |
| Onset melting temp. | ° C. | NA* | NA | 258.8 | 248.9 | 256.7 | 258.2 | 247.9 | 257.1 |
| Heat of fusion/melting | J/g | NA | NA | 41.6 | 33.7 | 46.2 | 39.6 | 43.3 | 29.0 |
| Onset crystallization | ° C. | NA | NA | 206.1 | 185.5 | 207.7 | 207.2 | 185.8 | 203.6 |
| Temp (T_{c}) | | | | | | | | | |
| Heat of crystallization | J/g | NA | NA | −33.9 | −28.7 | −45.8 | −38.7 | −39.7 | −47.3 |
| (delta H_{c}) | | | | | | | | | |
| Peak melting temp. (Tₘ) | ° C. | NA | NA | 254.6 | 246.8 | 253.7 | 255.4 | 244.5 | 252.8 |
| Tₘ-T_{c} | ° C. | NA | NA | 52.7 | 63.4 | 49.0 | 51.0 | 62.1 | 53.5 |
| MVR at 265° C., 5 Kg, | cm³/10 min | 51.7 | 49.1 | 49.7 | 33.0 | 117.0 | 33.0 | 51.9 | 36.7 |
| 360 s | | | | | | | | | |
| MVR at 265° C., 5 Kg, | cm³/10 min | NA | NA | 92.6 | 49.7 | 136.0 | 42.8 | 72.0 | 48.7 |
| 1080 s | | | | | | | | | |

*NA = not available

### Discussion

The results shown in Tables 2 and 3 indicate that it is possible to make a glass-filled polyester composition having high gloss by selecting a specified ratio of polybutylene terephthalate (PBT) and polyethylene terephthalate (PET), specifically wherein the article further exhibits a gloss that is more than 75 gloss units, as measured at 60 degrees, which gloss varies from the average less than 10 gloss units in the glossy region, when based on six equally spaced locations in the glossy region. The variation is represented by the standard deviation in the Table.

The compositions of Comparative Examples A-F do not meet these properties. It can be seen that for Examples E and F in Table 3, when no PBT is present in the formulations, at a glass fiber content is 15 wt. %, defects showed on the surface and the 60 degree gloss was on average 40 and 12 gloss units, respectively, for Comparative Examples E and F. Example E with the low IV PET showed better gloss than Example F with high IV PET, but neither performed as well as Example 1 and 2 with either low IV PET or High IV PET in combination with PBT.

Surprisingly, it can be seen that for Examples A and B in Table 3, when a relatively high ratio of PBT to PET was present in the formulation, 4.6 and 1.8, respectively, surface defects still occurred and, while the average 60 degree gloss improved to 43 and 66 gloss units, respectively, the performance was still below that of Examples 1 and 2, in which the ratio of PBT to PET was 0.86. Similarly, it can be seen that for Examples C and D in Table 3, when a relatively low ratio of PBT to PET was present in the formulation, specifically a ratio of 0.20, then surface defects again occurred and the average 60 degree gloss declined still further below that of Comparative Examples A and B, to 30 and 23 gloss units, respectively. The variation in gloss, as indicated by standard deviation, however, was improved over Comparative Examples A and B. Thus, inventive Examples 1 and 2 was unexpectedly found to show a so-called sweet spot in terms of both high gloss and low variation in gloss.

The data in Table 3 further showed that the improvement in gloss and variation in gloss was not at the expense of poor heat stability or impact strength, while melt viscosity was remained acceptable. In particular, comparing the 6 and 18 minute MVR at 265° C., for examples 1 and 2 showed less than a 40% MVR change under these abusive conditions: increasing from 51.9 to 72.0 cm³/10 min and from 36.7 to 48/7 cm³/10 min respectively. The Izod notched impact strength (5 lb hammer) was 43.7 J/m

All patents and applications cited herein are incorporated by references. While the invention has been described with reference to a preferred embodiment, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A hollow molded article, comprising a surface of which at least a portion is a glossy surface, which is integrally molded from a thermoplastic polyester composition,
(a) wherein said composition comprises:
28 to 50 wt. % polybutylene terephthalate with a melting point of 210 to 230° C.;
10 to 30 wt. % of glass fiber with a diameter of 9 to 20 microns;
20 to 62 wt. % polyethylene terephthalate with a melting point of 240 to 260° C. and a diethylene glycol group content of 0.5 to 2.5 wt. %; and
0 to 5 wt. % of a colorant, an antioxidant, a mold release agent, a stabilizer, or a combination thereof, based on 100 parts by weight of the combination of the polybutylene terephthalate, glass fiber and polyethylene terephthalate;
(b) wherein at least 10% of the surface of the article has a continuous glossy surface which forms a continuous glossy region having a gloss of at least 75 gloss units, as measured at 60 degrees in accordance with ASTM D523; and
(c) wherein said gloss varies from the average less than 10 gloss units in said glossy region.

2. The hollow molded article of claim 1, wherein the ratio of polybutylene terephthalate to polyethylene terephthalate in the polyester composition is from 0.50 to 1.20.

3. The hollow molded article of claim 1, wherein the polyethylene terephthalate has an intrinsic viscosity, of 0.50 to 1.10 dl/g and the polybutylene terephthalate (PBT) has an intrinsic viscosity of 0.5 to 0.9 dl/g, wherein deciliters per gram is measured in a 60:40 by weight phenol/1,1,2,2-tetrachloroethane mixture at 23° C.

4. The hollow molded article of claim 1, wherein the polyester composition further comprises from 0.1 to 10 weight percent, based on the total weight of the polymers in the composition, of further polyester selected from the group consisting of polyethylene naphthalate, polybutylene naphthalate, polytrimethylene terephthalate, poly(1,4-cyclohexylenedimethylene 1,4-cyclohexanedicarboxylate), poly(1,4-cyclohexylenedimethylene terephthalate), poly(cyclohexylenedimethylene-co-ethylene terephthalate), or a combination comprising at least one of the foregoing polyesters.

5. The hollow molded article of claim 1, wherein the glass fiber has a length of 0.01 to 1.0 mm.

6. The hollow molded article of claim 1, wherein the polyester composition further comprises from 0.01 to 0.50 wt. % of antioxidant selected from the group consisting of phosphites, phosphonites and mixtures thereof.

7. The hollow molded article of claim 1, wherein the polyester composition further comprises from 0.1 to 1.0 wt. % of a mold release selected from the group consisting of: aliphatic polyesters, poly alpha olefins, aliphatic polyamides, carboxylic acid salts and mixtures thereof.

8. The hollow molded article of claim 1, wherein thermoplastic polyester composition further comprises:
35 to 45 wt. % polybutylene terephthalate with a melting point of 210 to 230° C.; and
10 to 20 wt. % of glass fiber with a diameter of 9 to 15 microns.

9. The hollow molded article of claim 1, wherein the polyester composition further comprises from 0.1 to 5 wt. % of a colorant, based on 100 parts by weight of the combination of the polybutylene terephthalate, glass fiber and polyethylene terephthalate, wherein the colorant is selected from the group consisting of carbon black, zinc sulfide, and a combination thereof.

10. The hollow molded article of claim 9, wherein the carbon black has a particle size of 10 to 25 nm.

11. The hollow molded article of claim 1, wherein the article is a handle for a large appliance.

12. The hollow molded article of claim 11, wherein at least 30% of the outer surface of the handle has a continuous glossy region with a gloss of at least 75 gloss units, as measured at 60 degrees in accordance with ASTM D523; and wherein said gloss varies from the average less than 10 gloss units in said glossy region.

13. The hollow molded article of claim 11, wherein at least a portion of the outer surface of the article has a non-glossy or textured surface.

14. The hollow molded article of claim 1, wherein the polyester composition, in the form of pellets, has a melt viscosity (MVR), as measured by ASTM D1238, at 265° C. for 360 seconds using a 5 kg weight after equilibrating for 360 sec, of from 30 to 60 cm³/10 min and, after equilibrating for 1080 sec, of from 40 to 90 cm³/10 min.

15. The hollow molded article of claim 1, wherein a molded sample of the polyester composition exhibits a heat deflection temperature of at least 200° C. at 66 psi (0.455 MPa) as measured by ASTM D648.

16. The hollow molded article of claim 1, wherein a molded sample of the polyester composition exhibits an Izod notched impact strength of at least 40 J/m, as measured by ASTM D256.

17. A hollow molded article, comprising a surface of which at least a portion is a glossy surface, which is integrally molded from a thermoplastic polyester composition,
(a) wherein said composition comprises:
35 to 45 wt. % polybutylene terephthalate with a melting point of 210 to 230° C.;
10 to 20 wt. % of glass fiber with a diameter of 9 to 15 microns;
30 to 54.9 wt. % polyethylene terephthalate with a melting point of 240 to 260° C. and a diethylene glycol group content of 0.5 to 2.5 wt. %;
0.1 to 5 wt. % of a colorant, based on 100 parts by weight of the combination of the polybutylene terephthalate, glass fiber and polyethylene terephthalate; and
0 to 5 wt. % of an antioxidant, a mold release agent, a stabilizer, or a combination thereof, based on 100 parts by weight of the combination of the polybutylene terephthalate, glass fiber and polyethylene terephthalate;
(b) wherein at least 10% of the surface area of the article has a glossy surface, which forms a continuous glossy region having a gloss of at least 80 gloss units, as measured at 60 degrees in accordance with ASTM D523; and
(c) wherein gloss varies from the average less than 10 gloss units in the glossy region.

18. A hollow molded article of claim 17 wherein the ratio of polybutylene terephthalate to polyethylene terephthalate in the polyester composition is from 0.50 to 1.20.

19. The hollow molded article of claim 17, wherein the article is a handle for a large appliance.

20. The hollow molded article of claim 19, wherein at least 30% of the outer surface of the handle has a continuous glossy region with a gloss of at least 75 gloss units, as measured at 60 degrees in accordance with ASTM D523; and wherein said gloss varies from the average less than 10 gloss units in said glossy region.

21. The hollow molded article of claim 19, wherein at least a portion of the outer surface of the article has a non-glossy or textured surface.

22. A hollow molded article, comprising an outer surface of which at least a portion is a glossy surface, which is integrally molded from a thermoplastic polyester composition,
(a) wherein said composition comprises:
28 to 50 wt. % polybutylene terephthalate with a melting point of 210 to 230° C.;
10 to 30 wt. % of glass fiber with a diameter of 9 to 20 microns;
20 to 62 wt. % polyethylene terephthalate with a melting point of 240 to 260° C. and a diethylene glycol group content of 0.5 to 2.5 wt. %; and
0 to 5 wt. % of a colorant, an antioxidant, a mold release agent, a stabilizer, or a combination thereof, based on 100 parts by weight of the combination of the polybutylene terephthalate, glass fiber and polyethylene terephthalate;
(b) wherein at least 10% of the outer surface area of the article has a glossy surface, which forms a continuous glossy region having a gloss of at least 75 gloss units, as measured at 60 degrees in accordance with ASTM D523;
(c) wherein said gloss varies from the average less than 10 gloss units in said glossy region; and
(d) wherein the article is made by a gas-assisted injection molding process.

23. A method of forming the hollow molded article of claim 1, which method comprises
mixing the components of the polyester composition;
introducing the polyester composition as a molten material into a molding apparatus adapted for gas-assisted injection molding;
introducing a gas into the molding apparatus to hollow the molten material by producing a gas channel at least partially through the molten material, expanding the molten material and replicating the surface and shape of the mold;
cooling the molten material so that it is a solid; and
removing the solid hollow molded article that has been formed from the molding apparatus.

24. The method of claim 23 wherein the hollow molded article is obtained by gas-assisted injection molding at a melt temperature of 260 to 290° C.

25. A method of using the hollow molded article of claim 1 wherein the article forms a handle that is permanently attached to an apparatus, the method comprising a person manually grasping the handle and thereby moving the apparatus or a movable portion thereof.

26. The method of claim 25 wherein the handle is attached to a large appliance.
